(19) United States
(12) Patent Application Publication
(10) Pub. No.: US 2004/0154447 A1
(43) Pub. Date: Aug. 12, 2004

(54) Apparatus for perforating a packaging film at controlled perforating speed

(75) Inventors: Catello Di Carlo, Bologna (IT); Cristian Zagnoni, Calcara Di Crespellano Bologna (IT)

Correspondence Address: Richard J. Minnich, Esq., Fay, Sharpe, Fagan, Minnich & McKee. LLP, Seventh Floor, 1100 Superior Avenue, Cleveland, OH, 44114-2518, US

(73) Assignee: T.M.C. S.p.A.

(21) Appl. No.: 10/360,073

(22) Filed: Feb. 6, 2003

(51) Int. Cl. B26D 1/56

(52) U.S. Cl. 83/311

(57) ABSTRACT

An apparatus for perforating a packaging film comprises at least one rotary cutter, which is rotationally driven by suitable drive means, and a fixed cutter, the cutters having respective blades by which a packaging film moving between the knives themselves on a supporting surface is perforated at regular intervals. The rotary knife is rotated by drive means which move it at a controlled speed of rotation that varies within one full angular revolution.

### BACKGROUND OF THE INVENTION

The present invention relates to an apparatus for perforating a packaging film, in particular a plastic film, used for wrapping products.

In prior art packaging machines used to wrap multipacks of toilet or kitchen paper rolls, a wrapping machine is usually fed with a web of film which is: unwound from a reel; perforated along suitably spaced tear lines; and then torn into sheets, each of which is used to wrap up a group of products; the entire process being performed fully automatically.

The step of perforating the film to create lines along which the film can subsequently be torn into separate sheets can be performed using any of several different methods. One of these methods includes the use of perforating apparatus equipped with a rotary cutter and a fixed cutter, placed opposite each other, between which the packaging film proceeds on an interposed supporting surface.

The optimum perforating speed of the rotary cutter is calculated on the basis of the characteristic parameters of the perforating process, including the physical and chemical properties of the film material, the properties of the cutter blade materials, the time interval required between one blade sharpening operation and the next, and the influence of machine vibrations and film feed rate on cutting efficiency, both of these factors being closely connected with desired hourly productivity. Once the most suitable nominal speed has been established, the cutter is maintained at this speed and works at a constant speed.

This arrangement, which applies to all prior art machines of this type, does, however, have some disadvantages due to the fact that the production capacity of the machine is directly proportional to the rotation speed of the rotary cutter, that is to say, to the perforation speed of the cutting unit as a whole.

Increasing the speed of the cutter in order to increase the productivity of the machine leads to limit conditions which, from a practical viewpoint, cannot be exceeded. When a certain speed is exceeded, conditions which have little effect at lower speeds assume magnified proportions, altering perforating performance and nullifying most of the advantages derived from increasing the nominal speed of the cutters. Raising the speed of the apparatus makes it necessary to also increase the interference between the blades. This in turn increases wear and reduces blade life. Higher speeds also lead to more vibrations, which reduce the efficiency of the perforating apparatus.

### SUMMARY OF THE INVENTION

The main aim of the present invention is to overcome the above mentioned disadvantages by providing an apparatus that allows perforation speed to be made independent of the production speed of the machine in such a way that the production capacity of the machine can be increased without affecting optimum perforating conditions relative to speed.

Accordingly, the invention provides an apparatus for perforating a packaging film comprising at least one rotary cutter, which is rotationally driven by suitable drive means, and a fixed cutter, the cutters having respective blades by which a packaging film moving between the knives themselves on a supporting surface is perforated at regular intervals, wherein at least the rotary knife is rotated by drive means which move it at a controlled speed of rotation that can be varied within one angular revolution.

The control of the instantaneous rotation speed of the first rotary cutter enables perforation to be performed at an optimum speed, mainly low, during which the cutter moves through a limited angle, and to complete the revolution at a much higher speed, moving through the remaining angle which, together with the angle at which perforation is performed, adds up to 360°. The rotary cutter therefore accelerates and decelerates according to its position relative to the fixed cutter. Thus, the productivity of the apparatus considerably increased by acting solely on the part of the total angle of rotation through which the cutter travels without working: perforation, on the other hand, is always performed at the optimum speed required for this operation.

Moreover, the apparatus may comprise a rotating drum, driven by the aforementioned drive means, and which, in addition to the first rotary cutter, also mounts a second rotary cutter operating at a different angle and designed to apply easy open perforations to the film. In this case, the apparatus not only offers the advantage of controlling the operating angles of the rotary cutters in such a way as to increase production by suitably accelerating and decelerating cutter rotation, but also permits flexible control of the location of the easy open perforations relative to the edges of the packaging sheet and in accordance with specific requirements in terms of package functionality and appearance.

### BRIEF DESCRIPTION OF THE DRAWINGS

The technical characteristics of the invention, with reference to the above aims, are clearly described in the claims below and its advantages are apparent from the detailed description which follows, with reference to the accompanying drawings which illustrate a preferred embodiment of the invention provided merely by way of example without restricting the scope of the inventive concept, and in which:

FIG. 1 is a schematic assembly view, with some parts cut away in order to better illustrate others, showing an elevation of the apparatus according to the present invention;

FIGS. 2 and 3 are approximate, non-restricting diagrams showing the rotation speed of a rotary cutter mounting drum forming part of the apparatus according to the invention.

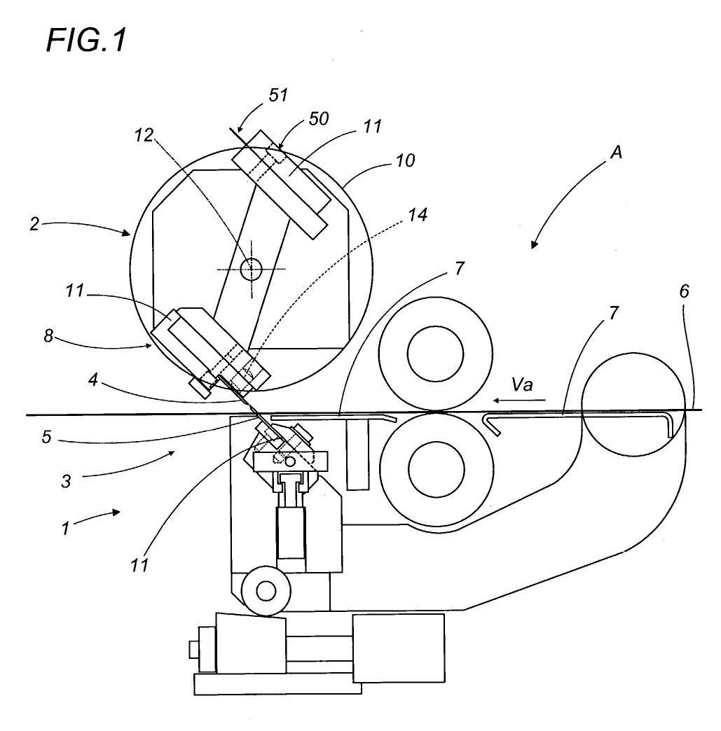

### DESCRIPTION OF THE PREFERRED EMBODIMENTS

With reference to the accompanying drawings, the numeral 1 denotes in its entirety an apparatus for perforating a plastic packaging film 6 used to wrap rolls of toilet or kitchen paper in packs of different sizes.

The apparatus 1 essentially comprises a drum 10 that rotates about a horizontal axis 12, driven by suitable drive means and mounting one or more rotary cutters 2, 50 set at suitable angular intervals from each other around the axis of rotation 12. The apparatus 1 further comprises a fixed cutter 3 and a supporting surface 7 on which the packaging film 6 is fed in such a way that it moves between the cutters 2, 50 and 3.

In the preferred embodiment described here, there is a first rotary cutter 2 that interacts with a fixed cutter 3 to apply cutting perforations along which the packaging film 6 will be torn into separate sheets; and a second rotary cutter 50 designed to apply easy open perforations which facilitate opening of the package by the end user.

The cutters 2, 50, 3 include blades 4, 5, 51 housed in sockets 11 in blade holders 8 in which the blades 4, 5, 51 are mounted using customary mounting means. As the drum 10 rotates, the rotary cutters 2, 50 periodically interact with the fixed cutter 3 in such a way as to apply two rows of perforations, at a distance from each other that varies in accordance with the synchronization between the drum 10 rotating at speed V and the film moving forward in a straight line at feed speed Va.

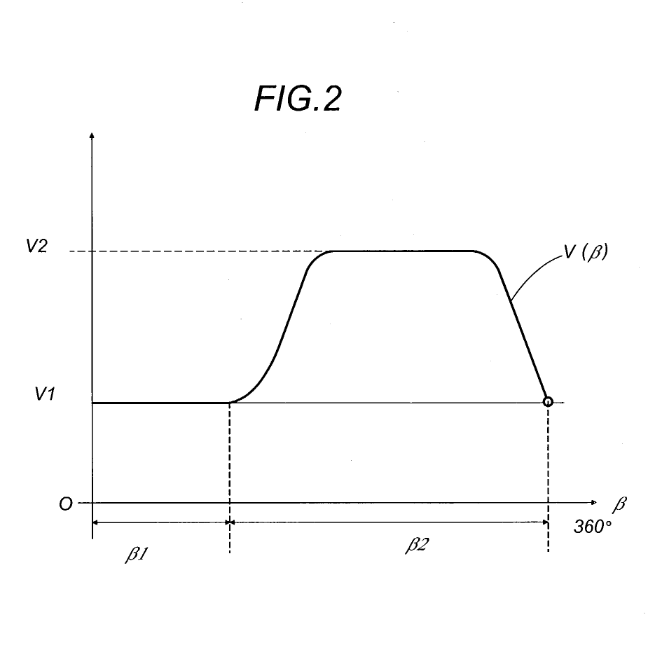

More specifically, the drum 10 is rotated by drive means which move it at a speed of rotation V(β) that varies within one full angular revolution (FIG. 2).

Considering for the moment only the first rotary cutter 2, during one full rotation of the drum 10 and for the part β1 of the angle of rotation in which the first rotary cutter 2 interacts with the fixed cutter 3, the rotation speed V(β) is kept constant at a first value (V1) defined as optimum to apply the perforations. When the first rotary cutter 2, after applying the perforations, moves away from the fixed cutter 3 in an inoperative condition, the drum 10 is driven in such a way as to describe the remaining angle of rotation β2—being the difference between the angle β1 and one full rotation—at an average speed that is considerably higher than the speed V1. This is accomplished by initially accelerating the drum rapidly, keeping it at a maximum speed V2 and then decelerating it so that the rotary cutter 2 is again moving at the optimum perforating speed when it applies the next row of perforations. This cycle is repeated in exactly the same way for each full rotation of the drum 10.

In other terms, while the cutting perforations are applied at the speed V1 defined as optimum for this operation, the drum 10 travels through the angular interval in which the rotary cutter 2 is inoperative at a variable speed V(β) and, in any case, at an average speed calculated over the angle β2, that is much higher than the optimum perforating speed V1.

By suitably correlating and synchronizing the instantaneous rotation speed V of the drum 10 and the feed speed Va of the packaging film 6, it is possible to significantly reduce idle cycle time, thus increasing the productivity of the apparatus 1 accordingly, without in any way modifying the optimum perforating conditions affecting the efficiency of the cutters 2, 3.

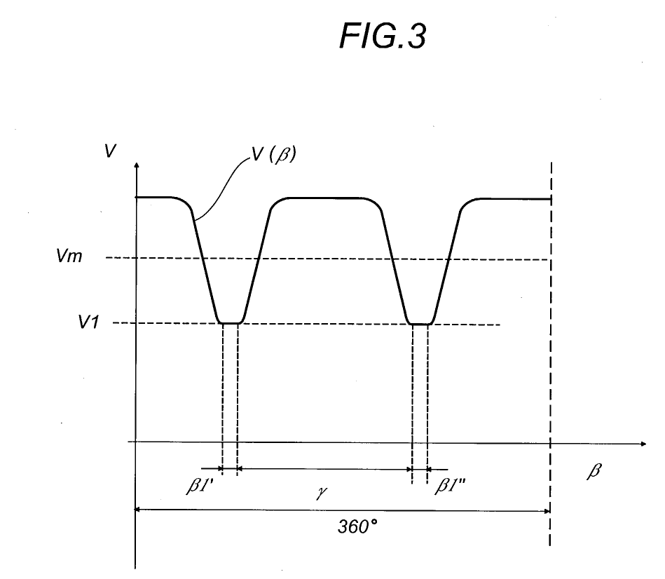

When the drum 10 is also equipped with a second rotary cutter 50, the law by which speed V(β) is varied (represented by way of example in FIG. 3) is similar to that described above except that there are two angular intervals β1′ and β1″ at which perforations are applied at the optimum perforating speed and during which the fixed cutter 3 interacts with the first rotary cutter 2 and with the second rotary cutter 50, respectively.

By suitably controlling the angular interval y separating the intervals β1′ and β1″ to also take into account the timing difference between the rotary cutters 2, 50 on the drum 10, it is possible to determine the position of the row of easy open perforations on the sheet of packaging film according to the type of package required and the requirements of the users of the apparatus 1.

It is therefore easy to customize the position of the easy open perforations without having to adjust the mechanical parts of the apparatus 1.

In practical terms, the above results can be accomplished in a relatively simple and economical manner by having the drum 10 drive means (embodied, for example, in a customary brushless motor) to electronic control means capable of controlling the law of variation of the rotation speed V(β) of the cutter or cutters 2, 50. These electronic control means can be embodied as a PLC interconnected with the drive motor of the drum 10 and suitably programmed according to the law of periodic variation of the speed V expressed as a function of the angle of rotation β of the drum 10 and represented purely by way of example in FIGS. 2 and 3.

In the embodiment described above, the rotation speed V(β) of the drum 10, that is to say, the set points of the cutters 2, 3 and 50, are controlled by electronic means.

Without departing from the scope of the inventive concept, however, the law of variation of the rotation speed V(β) of the drum 10 may be controlled by mechanical means, embodied, for example, as specially designed cams.

The creation of families of cams of different shapes and sizes that may be removed and/or selected when required makes it possible to customize the apparatus 1 to suit the specific features of each type of package wrapped.

The invention described has evident industrial applications and can be subject to modifications and variations without thereby departing from the scope of the inventive concept. Moreover, all the details of the invention may be substituted by technically equivalent elements.

What is claimed is

1. An apparatus for perforating a packaging film (6) comprising at least one rotary cutter (2; 50), which is rotationally driven by suitable drive means, and a fixed cutter (3), the cutters (2; 50, 3) having respective blades (4, 5, 51) by which a packaging film (6) moving between the cutters (2; 50, 3) themselves on a supporting surface (7) is perforated at regular intervals, wherein the rotational drive means drive at least one rotary cutter (2) at a rotation speed (V(β)) that varies within one full angular revolution.

2. The apparatus according to claim 1, further comprising a second rotary cutter (50) operating at a different angle from the first rotary cutter (2).

3. The apparatus according to claim 1 or 2, wherein the rotation speed (V(β)) has a first defined value (V1) that remains constant for an angle of rotation (β1′; β1″) during which the packaging film (6) is perforated, the speed (V(β)) then varying as the rotary cutter or each rotary cutter (2; 50) rotates or rotate through an angle (β2) remaining to complete one full revolution relative to the angle or angles of rotation (β1′; β1″).

4. The apparatus according to claim 3, wherein the rotation speed (V(β)) of the rotary cutter or of each rotary cutter (2; 50) is correlated with the feed speed (Va) at which the packaging film (6) moves forward on the supporting surface (7).

5. The apparatus according to any of the foregoing claims, wherein the drive means include a motor connected to electronic control means capable of controlling the law of variation of the rotation speed (V(β)) of the rotary cutter or of each rotary cutter (2; 50).

6. The apparatus according to any of the foregoing claims, wherein the drive means include cam means designed to impart on the rotary cutter or on each rotary cutter (2; 50) a rotation speed (V(β)) that varies according to a defined law.

7. The apparatus according to claim 6, wherein the cam means are removable.

8. The apparatus according to any of the foregoing claims, wherein the second rotary cutter (50) is designed to apply perforations on the packaging film (6) so as to permit easy opening of the product package.

9. The apparatus according to any of the foregoing claims, comprising a rotating drum (10) that mounts both the first rotary cutter (2) and the second rotary cutter (50), the drum (10) being rotationally driven at an instantaneous speed of rotation (V(β)) that varies as a function of the linear spacing required between the perforations applied to the packaging film (6) by the first rotary cutter (2) and those applied by the second rotary cutter (50).
